(19) United States
(12) Patent Application Publication
(10) Pub. No.: US 2025/0310871 A1
(43) Pub. Date: Oct. 2, 2025

(54) MANAGING UNIT AND METHOD IN A COMMUNICATIONS NETWORK

(71) Applicant: Telefonaktiebolaget LM Ericsson (publ), Stockholm (SE)

(72) Inventors: Omer Haliloglu, Istanbul (TR); András Rácz, Budapest (HU); Máté Szebenyei, Budapest (HU); Pål Frenger, Linköping (SE)

(21) Appl. No.: 18/866,676

(22) PCT Filed: May 17, 2022
(86) PCT No.: PCT/TR2022/050441

§ 371 Date: Nov. 18, 2024

(51) Int. Cl. H04W 48/20; H04W 48/08

(52) U.S. Cl. CPC H04W 48/20; H04W 48/08

(57) ABSTRACT

A method performed by a managing unit is provided. The method is for predicting a serving Access Point, AP, among one or more APs comprised in a subset of APs, to serve a User Equipment UE in a communications network. The UE is within a radio range of the one or more APs in the subset of APs. The managing unit obtains (302) a model associated to the subset of APs, for predicting the serving AP. The model is obtained based on training the model over a first training period. The managing unit obtains (303) a predicted AP from the subset of APs to serve the UE. The predicted AP is obtained based on invoking the model with INPUT data for prediction. The INPUT data for prediction comprises radio signal measurements from a set of reporting APs comprised in the subset of APs. The managing unit communicates (304) a first indication to at least the predicted AP. The first indication indicates the AP that is predicted to serve the UE, and that only the predicted AP shall forward signals received from the UE to a Central Processing Unit, CPU, via a fronthaul.

### TECHNICAL FIELD

Embodiments herein relate to a managing unit and methods therein. In some aspects, they relate to predicting a serving Access Point, AP, among one or more APs comprised in a subset of APs, to serve a User Equipment UE in a communications network.

### BACKGROUND

In a typical wireless communication network, wireless devices, also known as wireless communication devices, mobile stations, stations (STA) and/or User Equipments (UE)s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range, referred to as Millimeter wave (mmWave), have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

In Distributed massive MIMO (D-MIMO) a large number of antennas or Access Points (AP) are deployed in a geographical area such that the number of antennas is typically higher than the number of UEs. A UE is not associated with one particular access point but basically all APs in radio range of the UE take part in serving that UE. That's why, these systems are also called cell-less architectures. The signals of the multiple antennas receiving the user transmission in the uplink are typically combined using some MIMO receiver algorithm to boost the signal of the selected user while mitigating the interference from other users. In the downlink multiple APs coherently combine their transmission toward the intended user while avoiding interference to other users as much as possible.

Different variants of D-MIMO systems exist depending on how the signal combination of the distributed antennas are performed. The solutions vary from fully distributed to fully centralized according to which part of the signal processing is done locally in the AP or in a central processing unit (CPU). The more signal processing steps are centralized, the higher the demand on the fronthaul network. In the extreme case when all signal processing is central in the CPU, all the antenna signals need to be delivered to the CPU in the uplink. There can be hybrid cases where some processing is local in the AP, while others are centralized at the CPU or at a selected local AP cluster head.

The fronthaul and the available processing capabilities in the APs are the most important factors that determine the applicable D-MIMO radio processing solution and the deployment architecture. In case of a lightweight fronthaul solution, the APs can be organized in a daisy chain fashion as in the radio stripe solution case. In this case the short time scale radio processing is done in the APs, while the CPU is doing only longer time scale control, such as UE pilot allocation, and UE-AP assignment.

An example cascaded AP deployment is shown in FIG. 1. In FIG. 1 Channel measurement on uplink UE pilots shared with central CPU is depicted, where the uplink pilot transmissions of the UE is measured by all APs, which forward the channel measurement to the CPU. The channel knowledge is an important factor in all D-MIMO realization, since up-to-date, accurate channel knowledge is crucial in utilizing multi-antenna combining gains.

### SUMMARY

As part of developing embodiments herein, the inventors identified a problem that first will be discussed.

An important constraint in the D-MIMO architecture is fronthaul capacity, which may limit the sharing of antenna signals or channel measurements between the AP and the CPU or between APs. Performing fully centralized processing may not be feasible in many cases due to fronthaul bottlenecks, as it would require delivering antenna signals from each AP for uplink reception combining in the CPU. One way to overcome this problem is to send only a subset of the AP signals to the CPU, or the signal from only one selected, in the extreme case. However, in this case the serving AP(s) would need to be changed very rapidly according to how the radio signal fluctuates on the fast fading time scale in order to utilize the best signal, or set of signals, at each moment.

To make such fast AP switching in the naïve approach would be to collect channel measurements from all antennas in a central place or in a distributed fashion and then compare and select the best one. Then signaling back to the selected AP, which, in response, would send the UE signal up into the network. Such a solution would be infeasible as it requires sharing large amount of channel state information and would introduce an additional roundtrip delay in the communication.

An object of embodiments herein is to improve the performance in a communications network.

According to an aspect of embodiments herein, the object is achieved by a method performed by a managing unit. The method is for predicting a serving Access Point, AP, among one or more APs comprised in a subset of APs, to serve a User Equipment UE in a communications network. The UE is within a radio range of the one or more APs in the subset of APs. The managing unit obtains a model associated to the subset of APs, for predicting the serving AP. The model is obtained based on training the model over a first training period. The managing unit obtains a predicted AP from the subset of APs to serve the UE. The predicted AP is obtained based on invoking the model with INPUT data for prediction. The INPUT data for prediction comprises radio signal measurements from a set of reporting APs comprised in the subset of APs. The managing unit communicates a first indication to at least the predicted AP. The first indication indicates the AP that is predicted to serve the UE, and that only the predicted AP shall forward signals received from the UE to a Central Processing Unit, CPU, via a fronthaul.

According to another aspect of embodiments herein, the object is achieved by a managing unit configured to predict a serving Access Point, AP. The serving AP is predicted among one or more APs comprised in a subset of APs, to serve a User Equipment UE in a communications network. The UE is adapted to be in a radio range of the one or more APs in the subset of APs. The managing unit is further configured to:
Obtain a model associated to the subset of APs, for predicting the serving AP, which model is adapted to be obtained based on training the model over a first training period,
obtain a predicted AP from the subset of APs to serve the UE, which predicted AP is adapted to be obtained based on invoking the model with INPUT data for prediction, which INPUT data for prediction is adapted to comprise radio signal measurements from a set of reporting APs comprised in the subset of APs, and
communicate a first indication to at least the predicted AP, which first indication is adapted to indicate the AP that is predicted to serve the UE, and that only the predicted AP shall forward signals received from the UE to a Central Processing Unit, CPU, via a fronthaul.

Thanks to that a serving AP is predicted to serve the UE and that it is the predicted AP that shall forward signals received from the UE to the CPU via a fronthaul no other AP in the subset of APs needs to forward the signals received from the UE. In this way the uplink signal forwarding and channel measurement exchanges on the fronthaul network is reduced, while a performance similar to centralized processing where all APs need to forward their signals to the CPU is still maintained. This results in an improved performance in the communications network.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating embodiments of a communications network.

FIG. 3 is a flowchart depicting an embodiment of a method in a managing unit.

FIG. 4 is a schematic block diagram illustrating embodiments of a method.

FIG. 5 is a schematic block diagram illustrating embodiments of a method.

FIG. 6 is a schematic diagram illustrating embodiments herein.

FIG. 7 is a schematic signaling diagram illustrating embodiments herein.

FIG. 8 is a schematic signaling diagram illustrating embodiments herein.

FIG. 9 is a schematic diagram illustrating embodiments herein.

FIG. 10 is a schematic diagram illustrating embodiments herein.

FIG. 11a-b are schematic block diagrams illustrating embodiments of a managing unit.

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14-17 are flowcharts illustrating methods implemented in a communication system including a host computer, a base station and a user equipment.

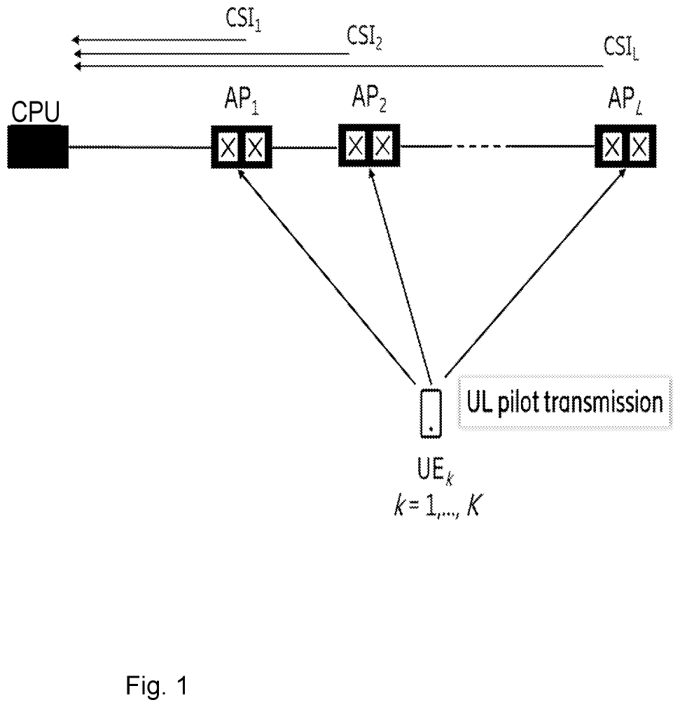

### DETAILED DESCRIPTION

### Demands and Challenges Dealt With by Embodiments Herein

A demand in a D-MIMO scenario according to embodiments herein, is an instantaneous best AP selection with local antenna processing done at AP level is assumed. This means that an AP resulting the best Signal to Noise Ratio (SNR) reception should be selected for UE signal decoding and a MIMO decoding is done considering the antennas of the selected AP only.

A UE uplink transmission is received and decoded by all APs, or at least a subset of APs 115, which perform local signal processing.

If the received signal quality, is deemed to be within the top-N best signal quality, then the AP forwards the received UE signal further up in the fronthaul to the CPU. This means that the APs are ordered according to their instantaneous signal qualities with respect to the given UE and select the top-N ones. In one extreme case, N=1, i.e., there is only one best AP, when only the best AP should forward the received signal. According to embodiments herein, the other APs, not considered to be within the top-N, do not need to transfer the UE signal, thereby relieving the fronthaul from additional load. The CPU node receives the uplink signal(s) and may perform further processing and combining of signals, in case top-N signals are delivered, where N>1.

The challenge in this D-MIMO setup is that the best AP, or top-N set, may change very rapidly basically on the channel coherence time scale, following fast fading fluctuations. A further challenge is that the best AP may be frequency selective, meaning that for some frequency sub-carriers one AP is the best while for another sub-carrier another AP. Therefore, the best AP should be selected such that the selected AP turns out to be the best on all or most of the sub-carriers on which the UE 120 is momentary scheduled.

It is required to measure the channel gains at all APs e.g. in the subset of APs 115, compare them and select the best AP. This means that all the APs would need to send the channel gains measured on the uplink reference symbols of the UE 120 to the CPU, and the CPU 140 would select the best one per UE and would signal it back to the APs and in response to that, the best AP would forward the received UE signal into the network. We note that for the best AP selection a distributed algorithm may also be used but in that case the APs would need to share peer-to-peer their measured channel gains and select the best with a distributed algorithm. In either cases the drawback, which is overcome by embodiments herein, would be the extra load on the fronthaul and the extra delay in the data flow caused by the back and forth signaling during AP selection).

The approach provided according to embodiments herein, relies on measuring the UE reference signals only in a subset of the APs and predicting the best AP or a candidate set comprising the best AP with an AI algorithm.

Examples of embodiments herein provide a method relating to training a model, and then using the model for predicting an AP among APs in a subset of APs, to serve a UE.

Training: The model for predicting the serving AP is obtained by training it over a training period. The model is associated to the subset of APs.

Predicting: Once the model is trained, INPUT data for prediction is fed into the model. The INPUT data for prediction comprises current radio signal measurements from a set of reporting APs comprised in the subset of APs. The model will then provide a predicted serving AP as OUTPUT.

An example of embodiments herein provide an AI based fast AP switching in D-MIMO.

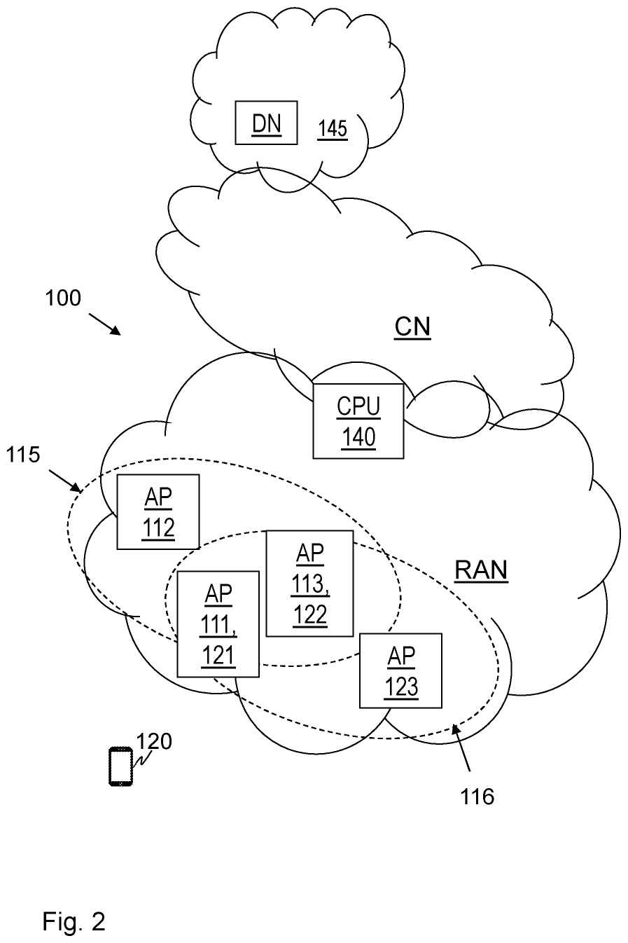

FIG. 2 is a schematic overview depicting a communications network 100 wherein embodiments herein may be implemented. D-MIMO systems may be used in the communications network 100. The communications network 100 comprises one or more RANs and one or more CNs. The communications network 100 may use a number of different technologies, such as mmWave communication networks, Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of APs operate in the communications network 100 such as e.g., one or more APs 111, 112, 113 and possibly one or more second APs 121, 122, 123. The one or more APs 111, 112, 113 are comprised in a subset of APs 115. The one or more second APs 121, 122, 123 are comprised in and updated subset of APs 116. This will be explained below.

The APs 111, 112, 113 121, 122, 123 each provides radio coverage in one or more cells which may also be referred to as a service area, a beam or a beam group of beams.

The APs 111, 112, 113 121, 122, 123 may each relate to any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, an NG-RAN node, a base transceiver station, a radio remote unit, an Access Point Base Station, a base station router, a transmission arrangement of a radio base station, a stand-alone access point or any other network unit capable of communicating with UEs, such as e.g. a UE 120, within a service area served by any of the APs 111, 112, 113 121, 122, 123 depending e.g. on the first radio access technology and terminology used. Any of the APs 111, 112, 113 121, 122, 123 may communicate with UEs such as a UE 120, in DL transmissions to the UEs and UL transmissions from the UEs. According to embodiments herein, the APs 111, 112, 113 121, 122, 123 may each use D-MIMO systems for the communication with the UEs.

A number of UEs operate in the communication network 100, such as e.g. the UE 120. The UE 120 may also referred to as a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g., smart phone, laptop, mobile phone, sensor, relay, mobile tablets or even a small base station communicating within a cell.

According to embodiments herein an AP will be predicted to serve the UE 120.

A managing unit 130 is operating in the communication network 100. The managing unit 130 is configured to predict a serving AP 111 for the UE 120 among the one or more APs 111, 112, 113 comprised in the subset of APs 115, and optionally among the second APs 121, 122, 123 comprised in the subset of APs 116 when updated. The managing unit 130 may comprise AI logic for the prediction.

The managing unit 130 may in some embodiments, be located in a CPU 140 operating in the communication network 100. In some other embodiments managing unit 130 located in each AP of the comprised in the subset of APs 115 or in the updated subset of APs 116.

In some further embodiments a first part of the managing unit 130 is located the CPU 140 and a second part of the managing unit 130 is located in each AP comprised in the subset of APs 115 or updated subset of APs, 116. Wherein e.g. the first part of the managing unit 130 trains the model and sends it to each AP of in the subset of APs. Each second part of the managing unit 130 in the respective AP performs its own training and obtains its own predicting of AP.

Methods herein may be performed by the managing unit 130. As an alternative, a Distributed Node (DN) and functionality, e.g. comprised in a cloud 145 as shown in FIG. 2, may be used for performing or partly performing the methods herein.

A number of embodiments will now be described, some of which may be seen as alternatives, while some may be used in combination.

Embodiments herein provide an online learning method where training of as model may be performed even locally in an AP and may be done continuously e.g., based on feedback from the CPU 140.

Example embodiments herein further provide an Artificial Intelligence (AI) based methodology to predict APs and e.g. the top-N antennas that may be considered at every moment in time when doing instantaneous AP and antenna selection to serve a particular UE. The prediction may be done based on INPUT data for prediction comprising local information only i.e., locally available in the AP or available in a local cluster head, that is fed into the trained model. The INPUT data for prediction is able to track the fast fading changes of signal fluctuations. The model then provides the predicted AP as OUTPUT from the model.

With this model training and prediction method, each AP may locally decide whether to forward the uplink received UE signal towards the network such that the best signal AP is included in the forwarded set.

Only the predicted AP shall forward signals received from the UE 120 to the CPU 140 via a fronthaul, while the APs that has not been predicted shall not forward signals received from the UE 120 to the CPU 140.

Some embodiments herein is further enhanced with the capability that the AP may consider the confidence of the prediction and the current traffic load on the fronthaul when deciding about forwarding a received uplink signal. In this way the AP may weigh its confidence of being the best AP vs. the fronthaul load, e.g., a signal predicted to be the best even at a low confidence level may be forwarded on the fronthaul in case of low fronthaul load.

An advantage of embodiments herein is that it reduces the uplink signal forwarding and channel measurement exchanges on the fronthaul network while still maintaining a performance similar to centralized processing where all APs need to forward their signals to the CPU. This reduces the requirements and cost implications on a D-MIMO deployment. Some embodiments herein may also use data traffic variations on the fronthaul, dynamically adjusting the selection of uplink signals according to traffic loads on fronthaul. Thereby all available fronthaul capacity is used in the best possible way, i.e., forwarding the top-N signals that fit into currently available capacity.

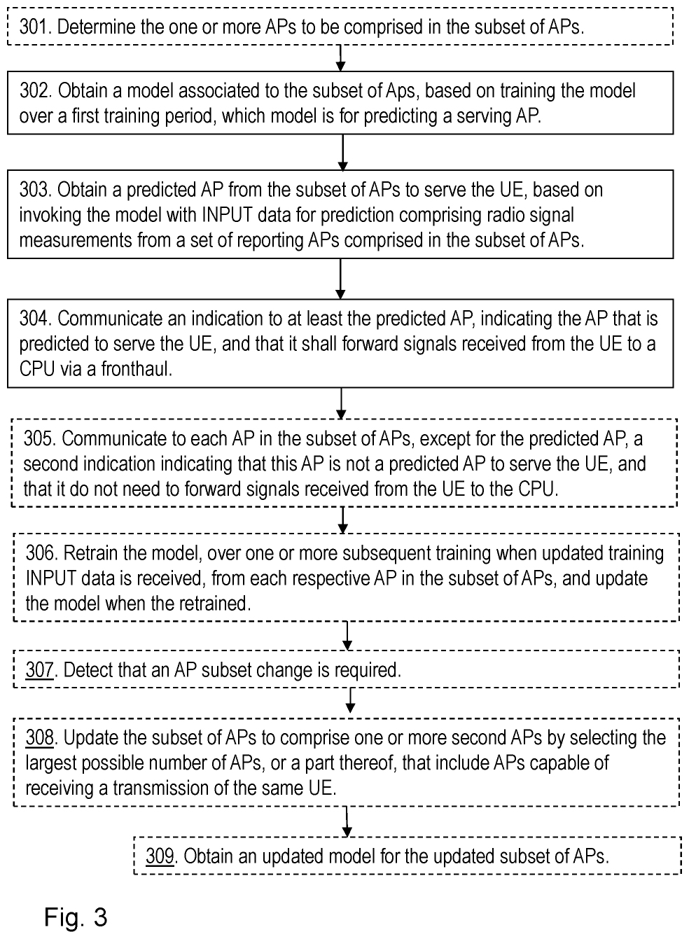

FIG. 3 shows example embodiments of a method performed by managing unit 130. The method is for predicting a serving AP 111 to serve a User Equipment UE 120 in a communications network 100. The serving AP 111 is predicted among one or more APs 111, 112, 113 comprised in a subset of APs 115 operating in the communications network 100. The UE 120 is within a radio range of the one or more APs 111, 112, 113 in the subset of APs 115.

The method comprises the following actions, which actions may be taken in any suitable order. Optional actions are referred to as dashed boxes in FIG. 3.

### Action 301

In some embodiments, the managing unit 130 determines the one or more APs 111, 112, 113 to be comprised in the subset of APs 115. The managing unit 130 may thus select which APs that should be contained in the subset of APs 115. This may e.g., be the APs that the UE 120 currently is within a radio range of, and or covering a certain geographical area. This may be performed by selecting the largest possible number of APs, or a part thereof, that include APs which are potentially capable of receiving a transmission of the same UE 120.

### Action 302—Training

The managing unit 130 obtains a model associated to the subset of APs 115. The model is for predicting the serving AP 111. The model is obtained based on training the model over a first training period. The managing unit 130 may train the model itself or receive it e.g., during network configuration.

In some embodiments, the managing unit 130 may be split between CPU 140 and APs 111, 112, 113 where the training may be performed in the CPU 140 and the CPU 140 may download the model to APs 111, 112, 113.

In some embodiments, the training of the model during the first training period is performed by receiving, e.g., from each respective AP 111, 112, 113 in the subset of APs 115, training INPUT data for the model continuously with a certain periodicity. The training INPUT data may comprise first channel gain measurement data from each respective AP 111, 112, 113 in the subset of APs 115. These are referred to as first channel gain measurement data simply to be able to different them from any subsequent channel gain measurement data as will be described below. Channel gain measurement data may e.g., comprise measurement on UE 120 uplink Sounding Reference Signal (SRS) including a complex valued channel gain. The first channel gain measurement data may be measured by the particular AP 111, 112, 113, i.e., each respective AP 111, 112, 113, on UL reference symbols transmitted by the UE 120. The first channel gain may be measured continuously with the certain periodicity within the first training period. The received training INPUT data is used for the training of the model during the first training period.

In some embodiments, each AP 111, 112, 113 in the subset of APs 115 may comprise a respective set of multiple antennas 11, 12, 13. In these embodiments the first channel gain measurement data is measured continuously with the certain periodicity within the first training period on UL reference symbols transmitted by the UE 120 and per antenna out of the multiple antennas 11, 12, 13 of the particular AP 111, 112, 113, and

The training INPUT data to the model continuously with a certain periodicity may be received from one or more APs 112 in the subset of APs 115.

To differentiate the INPUT data relating to the training, from the INPUT data relating to the prediction of a serving AP, the wordings training INPUT data and INPUT data for prediction respectively will be used herein.

### Action 303—Predicting

Now when the model is trained, it will be used for predicting a serving AP. Current INPUT data for prediction will be fed into the trained model and the trained model will provide OUTPUT data comprising the predicted AP 111. The aim is that the best AP or at least one of the best, regarding receiving the best signal quality from the UE 120 will be predicted.

The managing unit 130 obtains a predicted AP 111 from the subset of APs 115 to serve the UE 120. The predicted AP 111 is obtained based on invoking the model with INPUT data for prediction. The INPUT data for prediction comprises radio signal measurements from a set of reporting APs comprised in the subset of APs 115. This means that the reporting APs are a subset of the subset of APs 115. This will be explained more in detail below.

The model may be invoked with the INPUT data for prediction, continuously with a certain periodicity.

The INPUT data for prediction may comprises channel gain measurement data from each respective AP in the set of reporting APs.

Thus, the INPUT data for prediction comprises channel gain measurement data from each respective AP in the set of reporting APs, whereas the training INPUT data comprises first channel gain measurement data from each respective AP 111, 112, 113 in the subset of APs 115. This may be the same type of measurement that is used during the training INPUT data collection. This will be explained more in detail below.

### Action 304

The managing unit 130 communicates a first indication to at least the predicted AP 111. The first indication indicates the AP that is predicted to serve the UE 120, and that only the predicted AP 111 shall forward signals received from the UE 120 to the CPU 140 via a fronthaul. In this way the AP 111 gets to know that it has been predicted to be serving the UE 120 and that it has been appointed to forward signals received from the UE 120 to a Central Processing Unit, CPU, 140 via the fronthaul. A fronthaul when used herein, e.g. means the fixed network connection connecting the APs and the CPU and may comprise of optical and wired links. The fronthaul is also referred to as a fronthaul network herein. This first indication indicating may further be communicated to the other APs in the sub subset of APs 115, so that they can identify that they are not a predicted AP to serve the UE 120.

The first indication indicating the AP 111 that is predicted to serve the UE 120, may further indicates a confidence of the prediction of the predicted AP 111. This may be used by the predicted AP 111 as a basis to decide where it will eventually forward the UE 120 received signal to the CPU 140 considering other conditions as well, such as, for example, fronthaul traffic load. This will be explained more in detail below.

### Action 305

The managing unit 130 may in some embodiments communicate a second indication to each respective one or more APs 111, 112, 113 in the subset of APs 115, except for the predicted AP 111. The second indication indicates that this AP 111, 112, 113 is not a predicted AP 111 to serve the UE 120, and that this AP 111, 112, 113 do not need to forward signals received from the UE 120 to the CPU 140. This may be performed implicitly by sending the first indication, identifying the predicted AP 111, so if an AP receiving the first indication is not the indicated predicted AP 111 this indicates that that this AP 111, 112, 113 do not need to forward signals received from the UE 120 to the CPU 140. Thereby the first indication may become the second indication, when communicated to h respective one or more APs 111, 112, 113 in the subset of APs 115, except for the predicted AP 111.

The second indication indicating that this AP 111, 112, 113 is not a predicted AP 111 to serve the UE 120, may further indicate a confidence of not being predicted of the predicted AP 111.

### Action 306

In some embodiments, the managing unit 130 retrains the model, e.g., continuously over one or more subsequent training periods. This may be performed when updated training INPUT data is received, e.g., from each respective AP 111, 112, 113 in the subset of APs 115. The model is updated when the retraining has been performed.

The retraining of the model over the one or more subsequent training periods, may be performed continuously whenever anyone out of:
A data traffic load drops below a threshold. This is e.g., to utilize the available processing resources in the APs 111, 112, 113 to receive and process UE 120 transmissions to obtain training data without any impact on user traffic.
A fronthaul capacity is available. This is an advantage since we may utilize the momentarily available fronthaul capacity at low traffic loads, which would be otherwise left empty in such situations, to deliver training data to the managing unit 130.
A confidence level drops below a threshold. It is an advantage to use the confidence e.g., since it is an indication that a model prediction is no longer confident in the decision, which might be due to the radio propagation environment has changed and the distribution of training data has changed. In such cases a re-train or adaptation of the model may be necessary.
A measured hit rate drops below a threshold. This may be an indication that the accuracy of the model prediction has degraded e.g., due to the propagation environment changing or the location distribution of the UE 120 has changed or changes in the AP deployment, such as e.g., relocating of APs, deployment of new APs. In such cases, retrain or adaptation of the model or training of a new model from the start may be necessary.

### Action 307

In some embodiments, the managing unit 130 detects that an AP subset change is required. In these embodiments the subset of APs 115 may need to be updated. This may e.g., be caused by the UE 120 is moving out form a radio range of any of the APs in the subset of APs 115.

### Action 308

In these embodiments, when detecting that an AP subset change is required, the managing unit 130 updates the subset of APs 116 to comprise one or more second APs 121, 122, 123. This may be performed by selecting the largest possible number of APs, or a part thereof, that include APs which are potentially capable of receiving a transmission of the same UE 120.

### Action 309

In these embodiments, the managing unit 130 obtains an updated model for the updated subset of APs 116. This may be performed in a similar way as in Action 302 described above. The updated subset of APs 116 comprises the one or more second APs 121, 122, 123. The updated model shall replace the model.

The managing unit 130 may be located in any one out of the CPU 140. Or as an alternative, the managing unit 130 may be located in each AP. This means each AP comprised in the subset of APs 115 or updated subset of APs 116. In these embodiments each AP obtains 302 its own model by performing its own training and obtains 303 its own predicted of AP 111.

In some embodiments, each AP in the updated subset of APs 116 may comprise a respective set of multiple antennas 11, 12, 13. In these embodiments a subsequent channel gain measurement data is measured continuously with the certain periodicity within a respective subsequent training period on UL reference symbols transmitted by the UE 120 and per antenna out of the multiple antennas 11, 12, 13 of the particular AP.

In some embodiments, as a further alternative, a first part of the managing unit 130 is located the CPU 140 and a second part of the managing unit 130 is located in each AP comprised in the subset of APs 115 or updated subset of APs, 116. In these embodiments, the first part of the managing unit 130 is obtaining 302 the model and sends it to each AP of one or more APs 111, 112, 113, and each second part of the managing unit 130 performs its own training and obtains 303 its own predicting of AP 111.

The above embodiments will now be further explained and exemplified below. The embodiments below may be combined with any suitable embodiment above.

### Model Training Procedure

A model associated to the subset of APs 115 will be trained for predicting a serving AP 111. As mentioned above, the managing unit 130 may determine 301 the one or more APs 111, 112, 113 to be comprised in the subset of APs 115. This may be done by selecting the largest possible subsets that include APs which can receive the transmission of the same UE 120. In other words, if one AP from the subset of APs 115 is able to receive the UE 120 uplink pilot transmission, then the other APs in the subset of APs 115 would, most probably, be able to receive the UE 120 transmission. However, it is not possible to assume that all APs in the subset of APs 115 are capable to receive the same UE 120 at all times. It is an advantage to select as many APs 111, 112, 113 as possible to obtain a largest such subset 115. This is to limit the number of subset changes due to UE mobility and reduce the number of prediction models required. Due to practical limitations, it may be unrealistic to expect that all APs 111, 112, 113 in the subset of APs 115 should always be able to receive the same transmission from the UE 120. Therefore, a threshold indicating that, e.g., 90% of the APs should be able to receive transmissions from the same UE 120 and similarly a threshold for the fraction of the measurements for which this must be true may also be introduced, e.g., that for 85% of the measurement samples the above 90% AP rule must hold.

As mentioned above, the managing unit 130 obtains 302 a model associated to the subset of APs 115, for predicting the serving AP 111. The model is obtained based on training the model over a first training period and may be retrained 306 over one or more subsequent training periods.

The model training procedure may also be referred to as AI model training procedure herein. During the training procedure the APs 111, 112, 113 are sending measurement samples comprising the measured uplink reference signals from the UE 120 and e.g. the estimated channel gains for each UE such as the UE 120, to the managing unit 130 to obtain 302 the model. The model may be a neural model. A neural model when used herein e.g. means an artificial neural network with model parameters trained to the measurement data. In the managing unit 130, there may be multiple neural networks. This means that for example, each AP subset has its own model, where one neural network with trained parameters is one model. For example, there may be one model per AP subset. A suitable subset of APs, such as the subset 115, may be determined based on the measurement samples. Those APs that usually appear together in a measurement set, i.e., those which receive the uplink transmission of the same UE 120 may preferably be put together into one subset such as APs 111, 112, 113 are put together in the subset 115. The subset 115 may e.g. be associated with the locality of the APs 111, 112, 113 and those APs which are in the same locality from a radio channel perspective may preferably be put into one subset. Note that the subsets may typically be overlapping.

The managing unit 130 may create, train and maintain the model, such as a neural model, for each AP subset such as the subset of APs 115. The managing unit 130 may use only those measurement samples that include all the APs, or certain percentile of them, from the subset of APs 115 to train that particular model. During training, all the APs in the subset of APs 115 forward their respective uplink measurements to the managing unit 130. The training may be done continuously as new measurements are collected over one or more subsequent training periods, always updating the current model.

The training periods, i.e. the first training period and the one or more subsequent training periods, may be determined based on fronthaul data traffic loads. During low data traffic loads when the fronthaul is lightly loaded and there is spare capacity on the fronthaul, all the APs in the subset of APs 115 may send their respective channel measurement to the managing unit 130 and the model may then be trained with the new samples. In some embodiments, at high loads, no training samples are collected, only the inference is executed, i.e., only the measuring APs in the subset of APs 115 are forwarding their measurements to the managing unit 130 for inference purposes.

A special case is when each AP is a subset 115 of its own, i.e., including only the one AP in the subset of APs 115 and there is no measurement report sharing between APs or with the CPU 140. In this case the prediction may be done by each AP 111, 112, 113 based only on local data. The AP only predicts whether it is itself the best-AP or not. If it predicts itself as the best AP 111, it forwards the received UE signal to the CPU 140, otherwise not.

As mentioned above, different models would be trained for different AP subsets and measurements from any UE uplink reference transmissions, received by APs in the given subset, may be used for the training. There are no UE specific aspects in the model, the model tries to capture the channel propagation and variation patterns between the APs in the given subset.

When executing the model (i.e., during inference), the same model may be used for all UEs that have the same serving AP subset. The measured historical channel gain values, obtained per UE are the inputs to the model and the output is the predicted best AP for each UE.

When the model is trained it is time to feed the model with INPUT data for prediction. The INPUT data for prediction comprises current radio signal measurements from the reporting APs comprised in the subset of APs. The model will then provide a predicted serving AP as OUTPUT.

### AP Prediction Procedure

As mentioned above, the managing unit 130 obtains 303 a predicted AP 111 from the subset of APs 115 to serve the UE 120. The predicted AP 111 is obtained based on invoking the model with INPUT data for prediction comprising radio signal measurements from a set of reporting APs comprised in the subset of APs 115.

Before prediction an AP to serve the UE 120, a reporting set of APs within each AP subset may be determined. This means that the reporting APs are a subset of the subset of APs 115. The reporting APs are the only APs that report, in some embodiments continuously, the measurement results on UE 120 uplink reference signals and will send these measured channel gains to the managing unit 130. It will relieve the fronthaul from data traffic load when only the reporting APs that, are sending the measurement results. The remaining APs that will not share their measurements with the managing unit 130, these APs still perform measurements and UE signal reception, but will not load the fronthaul network e.g. continuously, only when they are selected as best AP or at training time. The selection of reporting APs may be done such that a diverse, uncorrelated set of APs are selected that give the best prediction possibilities. It may also be possible that multiple models for different AP measurement sets are built and the best one is kept at the end.

In the simplest case, we may use only one AP subset in the entire D-MIMO network, including all the APs in the network and one reporting subset only.

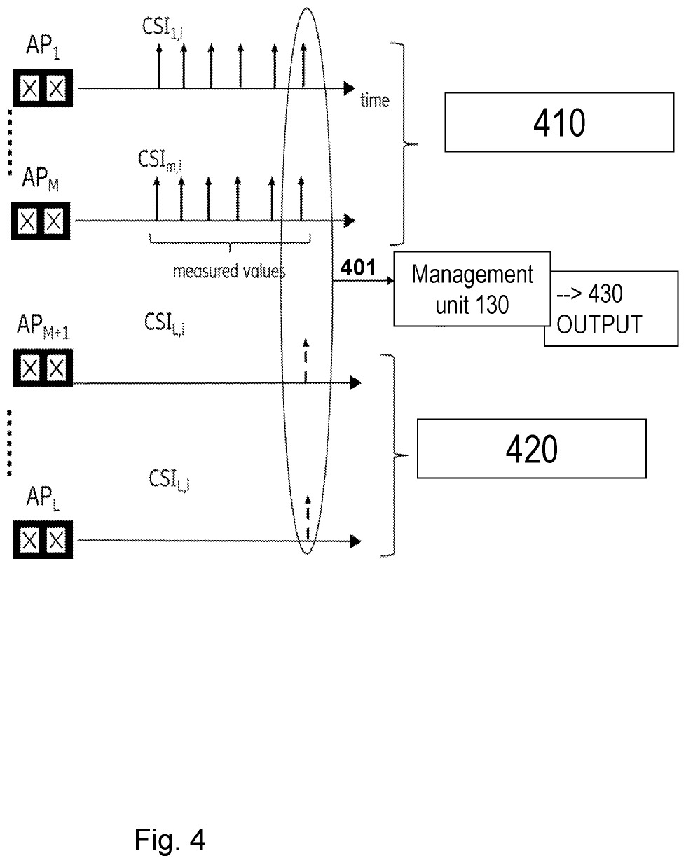

FIG. 4 depicts prediction of best AP in a generic case. FIG. 4 depicts INPUT data for prediction 401 and OUTPUT prediction data 430 in a generalized setting. Assume a total of L number of APs, each AP comprising multiple antennas, and a subset 115 of APs 111, 112, 113 here represented by the APs {1 . . . M} 410 that are continuously measuring UE reference signals with certain periodicity T_M, e.g., at every few ms, and these measurements, represented by uplink SRS measurement are forwarded to an AI algorithm in the managing unit 130 to be used as INPUT data for the prediction 401. The managing unit 130 predicts at each measurement time interval, with the measurement as INPUT data for prediction 401 the best AP out of the total number of APs in the subset, i.e., including also APs M+1 . . . L with unknown signal quality 420. The OUTPUT prediction data 430 from the model comprises the predicted AP, e.g. comprising an index of the AP providing the best channel gain out of the total number of APs, i.e., including those that are not measured at all. For that prediction the managing unit 130 e.g. an AI algorithm of the managing unit 130, takes a windowed length of past measurement values in order to track the time variations of the signals. Since one AP typically has multiple antennas, the measurements need to be done per antenna, but the prediction is sufficient to be done for APs, since each AP may easily compare and select the best local antenna, there is no need to predict on antenna level within one AP.

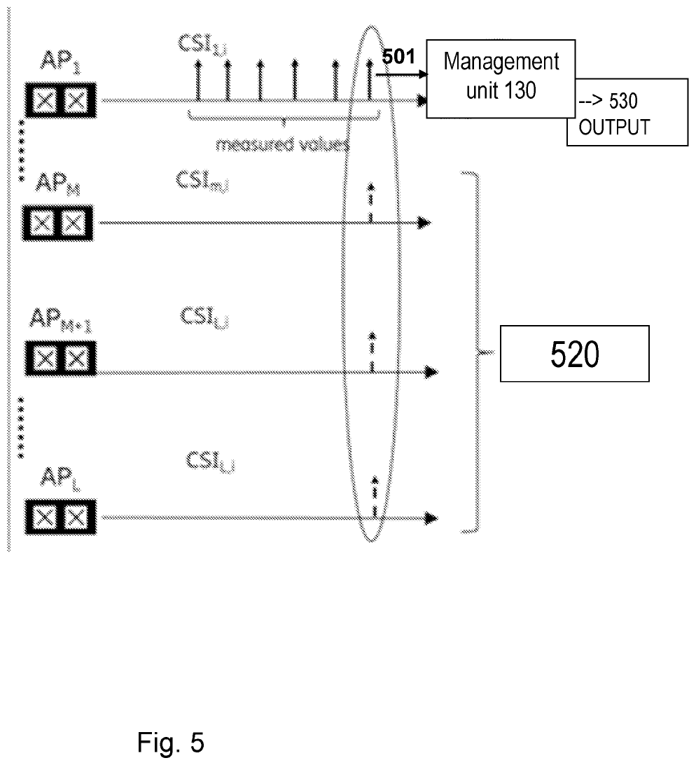

In some embodiments, the managing unit 130, e.g. comprising the AI logic, is local in each AP and each AP is using the measured signals on its local antennas to make a prediction. The prediction tries to determine the index of the AP (out of the whole AP set) that is having the best received signal quality. If the AP predicts that its own reception is the best, then it forwards the received signal toward the CPU 140. The scenario is illustrated in FIG. 5. FIG. 5 depicts INPUT data for prediction 501 from AP1, e.g. the AP 111, and OUTPUT prediction data 530 from the management unit 130 located in in that AP1 in embodiments wherein the managing unit 130 is local. The APs 2 . . . L has unknown signal quality 520.

The AI algorithm used by the managing unit 130 for the prediction may e.g. be either an Long Short Term Memory (LSTM) neural network or a deep neural network as well other suitable structures. Many different neural architectures are possible to use for this prediction task without impacting the rest of the components of embodiments herein.

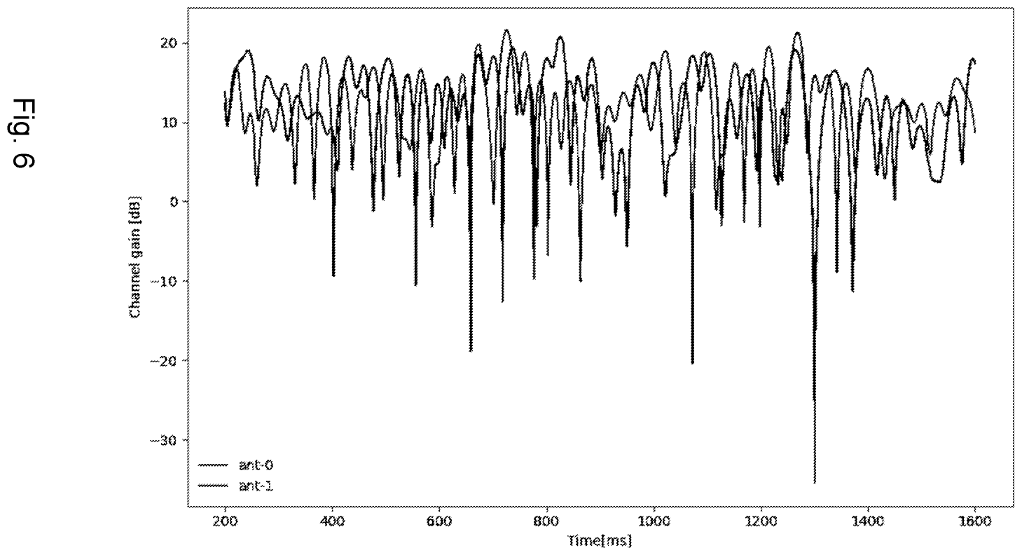

To illustrate the challenge of this kind of prediction, the measured channel gains on two antennas was plotted, assuming uncorrelated antennas and no path loss difference between the antennas. This is illustrated in FIG. 6, depicting an example channel gain fluctuations in case of two antennas. It can be observed that the signal can change rapidly and the best of the two signals may change on a similar time scale. The AI algorithm in the managing unit 130 tries to learn the patterns in the relative order of the antennas.

### Switching Between AP Subsets

This relates to and may be combined with Action 307-309 described above. As the UE is moving, it may occur that the AP subset for which the prediction is executed needs to be changed. Generally, it may be assumed that there are a few sets of APs, also depending on the size of the D-MIMO network, e.g., covering different parts of the network and each subset may have its own model and set of reporting APs used for the prediction. E.g. when the UE 120 moves out of the coverage area of one AP subset, e.g. the subset of APs 115, it may be necessary to switch to another AP subset, e.g., the subset of APs 116, and corresponding model related to that AP subset.

To detect 307 when an AP subset, e.g. the subset of APs 115, change is necessary, the following procedure may be used. One option is to detect 307 when an average signal strength of one or more of the APs in the reporting subset falls outside of the range typical for the given subset. The typical range may be determined during training time using statistical methods. For example, in one embodiment, the managing unit 130 determines the joint distribution of AP signal strength values and later tests whether new measurement samples are likely to originate from the same distribution.

In some other embodiments, the managing unit 130 uses a machine learning model for the AP prediction that inherently includes a confidence value in the decision. Such an approach is e.g. Bayesian networks, which may provide a confidence level along with the prediction. The managing unit 130 may determine the confidence level based on how similar the INPUT data for prediction is to the training INPUT used during the training of the model. If the model has not seen such data during training the confidence level will decrease. Thereby when the UE 120 is moving out of the coverage of the current subset of APs 115, the confidence level will decrease, and it may trigger to update 308 by changing AP subset, e.g. to the updated subset of APs 116 as mentioned above.

When an AP subset change, also referred to as update 308, gets triggered, then all candidate AP subsets need to start reporting to the managing unit 130 or the CPU 140, which may select the best subset. From that point on, the reporting APs in the new subset of APs 116, will be reporting the CSI for that UE 120 onwards and the model for AP prediction will be updated also referred to as switched, to the one corresponding to the new subset of APs 116.

### AP Subset Updates

In some embodiments the subset of APs 115, may need to be updated, also referred to as modified, e.g. if a change happens in the deployment, e.g., a new AP is deployed or displaced.

In another embodiment, the subset of APs 115, will be updated by being merged or new subsets may be created, if managing unit's 130 AI engine performance is not enough, i.e., the AI engine cannot predict the best AP in a fast and instantaneous way.

In some other embodiments, the subset of APs 115 will be updated by being merged or new subsets may be created, depending on the load in the fronthaul links.

### Implementation Architecture Options

The method of predicting the serving AP 111 among one or more APs 111, 112, 113 comprised in the subset of APs 115, to serve the UE 120 may be referred to as the prediction based best AP selection method. This method may be implemented in different architecture variants. Three main possible variants are described below.

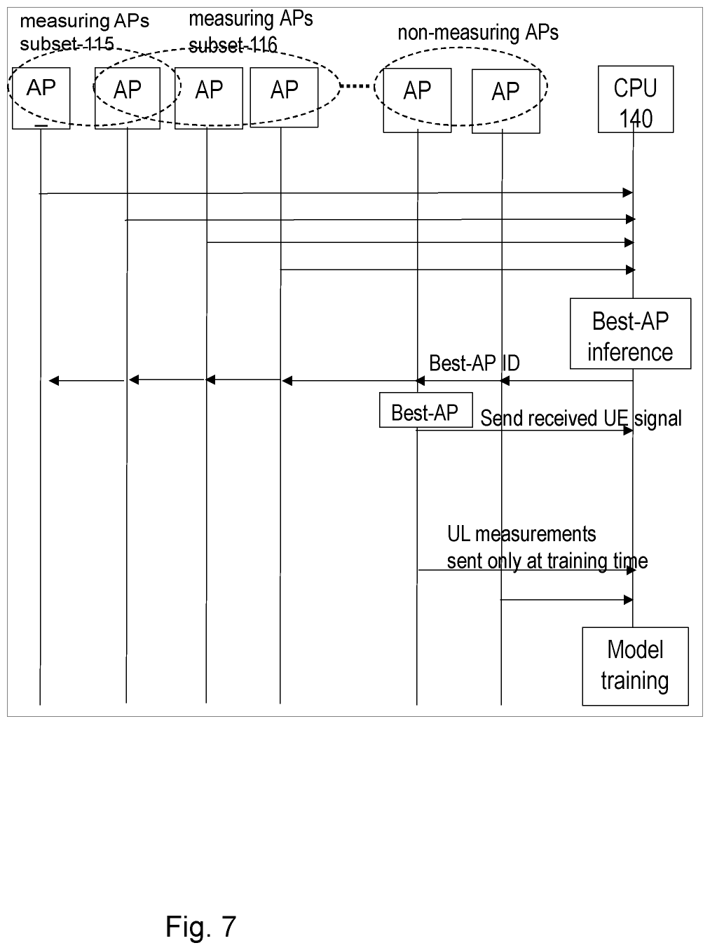

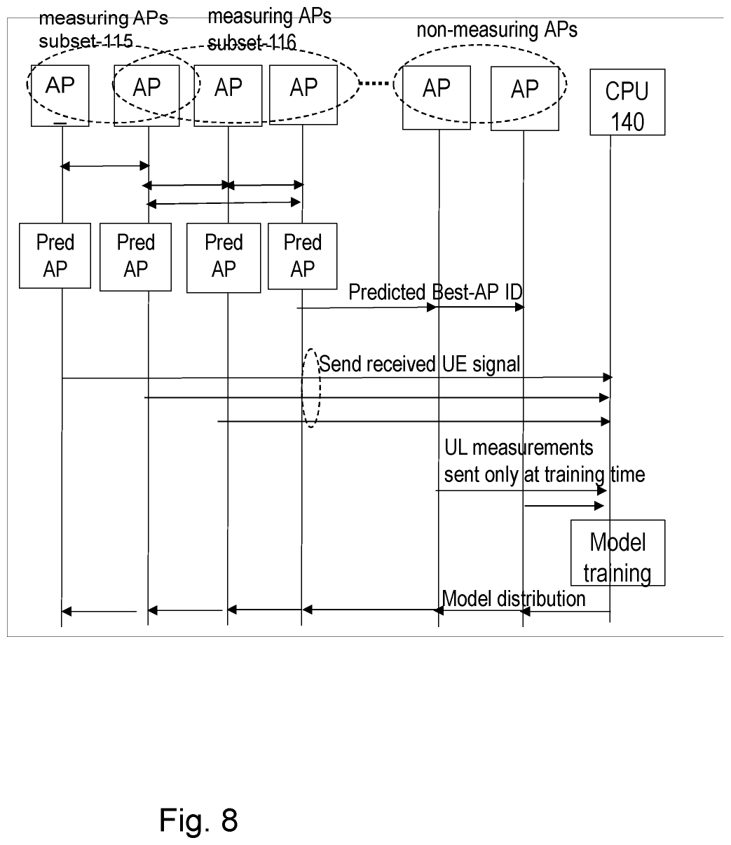

CPU centric. A signaling diagram of an example of this procedure is depicted in FIG. 7. In this case the managing unit 130 is located in the CPU 140 and this is the place where the models are both trained and executed for inference. This means that the APs in the subset of APs 115 and in the subset of APs 116, are forwarding their measurements periodically to the managing unit 130 in the CPU 140 and the managing unit 130 in the CPU executes the model, or executes the training, depending on which phase is currently running, and signals back the selected, i.e., an indication (e.g. an index) of the predicted AP 111 e.g. the best AP. Then the predicted AP 111 will forward the UE 120 received signal into the network such as to the CPU 140, while the other, non-predicted APs will forward the UE 120 received signal into the CPU 140 network, they will keep silent.

Peer-AP distributed. FIG. 5 depicts a signaling diagram of a best AP prediction in a peer-to-peer AP centric implementation.

In these embodiments, a part of the managing unit 130 is distributed to the APs. Here, the APs in the subset of APs 115 and in the subset of APs 116 execute the model locally and they exchange their measurements in a peer-to-peer fashion. The uplink measurements need to be exchanged only within the APs in the same subset, more specifically between the measuring APs of the same subset. Once each measuring AP has received the measurements from the other APs in the subset, they execute the best-AP inference and the one which is predicted to be the best will forward the UE 120 traffic to the CPU 140 in the network. In case an AP outside of the measurement set is predicted as best, one of the APs in the measuring set will forward the selection to that non-measuring AP.

The model training may still be performed by another part of the managing unit 130 located centrally in the CPU 140, which means that during training time the measurements are sent to the CPU 140 instead of between APs. The CPU 140 may distribute the updated model to the measuring APs.

Distributed with local data only. Some embodiments comprise a special case of the distributed scenario wherein a local managing unit 130 in the APs 111, 112, 113 in the subsets of APs 115 make their decision based only on the local measurement data available in the given AP, e.g. AP 111, i.e., on the multiple antennas of the AP 111. In this case the managing unit 130 needs to decide whether the signals measured on its own antennas are the best ones in the AP subset. In case it predicts to have the best signal strength, then it forwards the received UE 120 signals to the CPU 140 or other APs, cluster heads depending on the applied signal decoding method. In all other cases it does not send the received UE 120 signal any further, assuming that there will be another, better SNR AP which will receive the UE 120 signal.

Note that in this case the prediction of the AP 111 may be a little bit less conservative, i.e., the AI algorithm in the managing unit 130 may be less conservative with false-positive errors, i.e., it will forward the antenna signal even tough may not being the predicted one. However, false negative predictions should be avoided as much as possible, i.e., not forwarding a received signal although it is the best one. Such criteria's may be considered during the training procedure.

A benefit of this implementation embodiment is that it does not require prior information exchange between APs 111, 112, 113 or with the CPU 140 before making a prediction. Thereby it is simpler and may be faster in its prediction.

As an extension embodiment, the CPU 140 may provide instantaneous feedback to the APs about the correctness of best-AP decision. In case multiple APs have forwarded the UE signal, in the belief that their respective signal is going to be the best, the ones which turn out to be false positive, i.e., not being the predicted true best AP, may receive a feedback indication from the CPU. The APs may use this feedback to adjust its model locally.

Cluster head centric. This implementation is a hybrid of the fully distributed and fully centralized cases such that one of the APs 111, 112, 113, is selected as cluster head, which will collect the measurements from the other APs in the subset 115 and execute the prediction. In this way the cluster head acts like a local managing unit 130, e.g. a local CPU. The training may also be performed by the cluster heads or alternatively may be delegated to the central CPU 140.

### Coupling of the Managing Unit's 130 AI Logic to Fronthaul Status

A possible enhancement of embodiments herein, is to consider a current fronthaul load status when making the prediction of whether a certain AP should forward the uplink received UE 120 signal on the fronthaul towards the CPU 140. Such an enhancement may be especially useful in scenarios where there is no central entity to make one single prediction, but the AP prediction is performed locally, i.e., in the AP 111, 112, 113 or in local cluster heads. In such cases, each AP 111, 112, 113 deciding locally whether it should deliver the received uplink signal or not, may consider the confidence of its prediction, as well as the available fronthaul resources.

For example, when the managing unit 130 located in the AP 111, 112, 113 has a high confidence that its own signal is going to be the best in the subset, then it should forward the received UE 120 signal on the fronthaul more or less independently of the fronthaul current load status. Even if the managing unit 130 has a low confidence that the given AP is going to be the best but the fronthaul is currently only lightly loaded, it may still forward the received signal. However, at higher loads of the fronthaul, only the APs with the high decision confidence levels should forward their signals.

In this way the fronthaul is always kept at a high utilization such that always the “top-N” signals are occupying the fronthaul. When the number of active UEs such as the UE 120, is high then only the high confidence best AP signals will be forwarded from each UE but when the number of active UE is low, then even lower confidence level signals will be sent on the fronthaul and thereby improving the combined received signal for that particular UE.

The confidence level of the prediction may be measured, for instance, by using a softmax output layer in a neural network. A softmax layer outputs a normalized weighted output used to multi-class decisions. In this case, there would be as many classes on the softmax output layer as the number of APs and the normalized weights would be according to the likelihood of each predicted AP being the best.

### Example Implementation and Results

An implementation of the best-AP prediction method has been performed using channel measurements from an OFDM transceiver implementation. The measurements have been collected on a simulated propagation channel. In the experiment, two configurations were tested. In the first case comprised two antennas of two different APs, ant-0 and ant-1, and one, ant-0, out of the two was measuring continuously and the managing unit 130 tried to predict at each ms interval whether ant-0 or ant-1 is the best.

The results are plotted diagram of FIG. 9. FIG. 9 shows the measured channel gain on the two antennas and each dot on the curve corresponds to a prediction decision. The curve starting at close to the value of 30 on the Y axis corresponds to the channel variation measured on ant-0, while the other curve corresponds to ant-1. At each time instance, one dot is drawn on the antenna curve that is predicted to be the best one and another dot is drawn on the antenna curve that is the true best one. In case when the prediction selects the true best antenna, then the two circles overlap each other, hence only one dot is visible. When the prediction is false two dots can be seen at the given time instance, i.e., at the same X-axis value) As it can be seen, this happens only in a small fraction of the cases, altogether the prediction accuracy was around 90%.

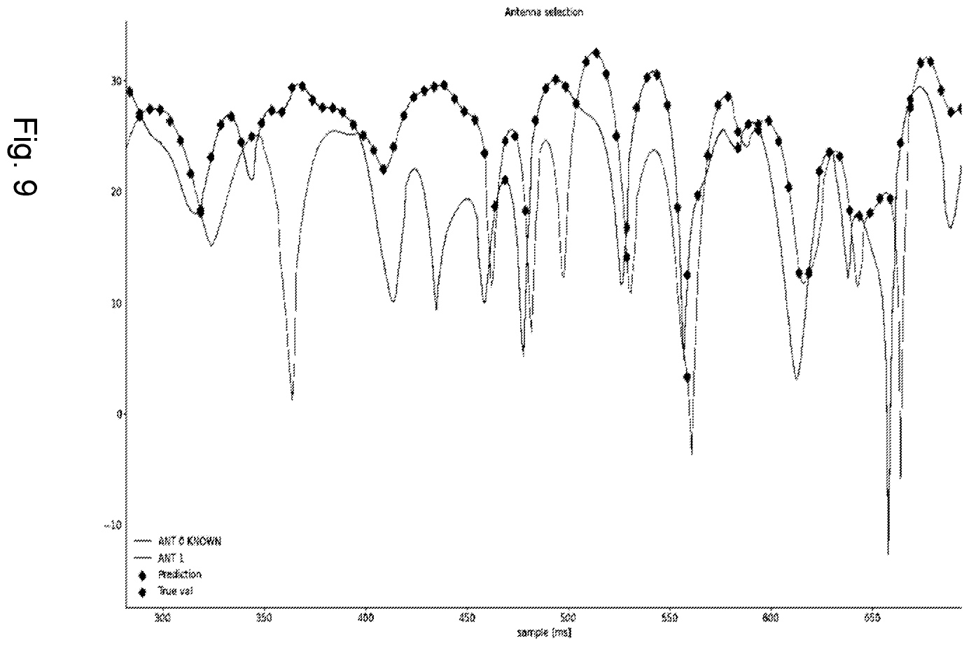

Also embodiments in a more demanding setting where one antenna is measured out of 5, have been tested with altogether five antennas at five different APs, ant-0, ant-1, ant-2, ant-3, and ant-4, wherein one antenna, ant-0, out of the five antennas has been measuring continuously. Based on this single antenna measurement the managing unit 130 AI logic predicts which antenna out of the five is the best. The results are shown in FIG. 10, using the same notations as in the previous case. As can be observed, the accuracy remains fairly good in this more difficult case as well.

It is noted that in these experiments, no path loss difference between the antennas has been assumed, which would, however, be common in a realistic situation. This means that the signal levels of different antennas would include a non-zero offset, which would make the distinction and prediction easier for the managing unit 130 AI algorithm.

Another practical consideration that would make the prediction more robust is that the managing unit 130 may predict a subset of the APs 115 such that the best AP is among this subset. This would make the prediction easier and more robust.

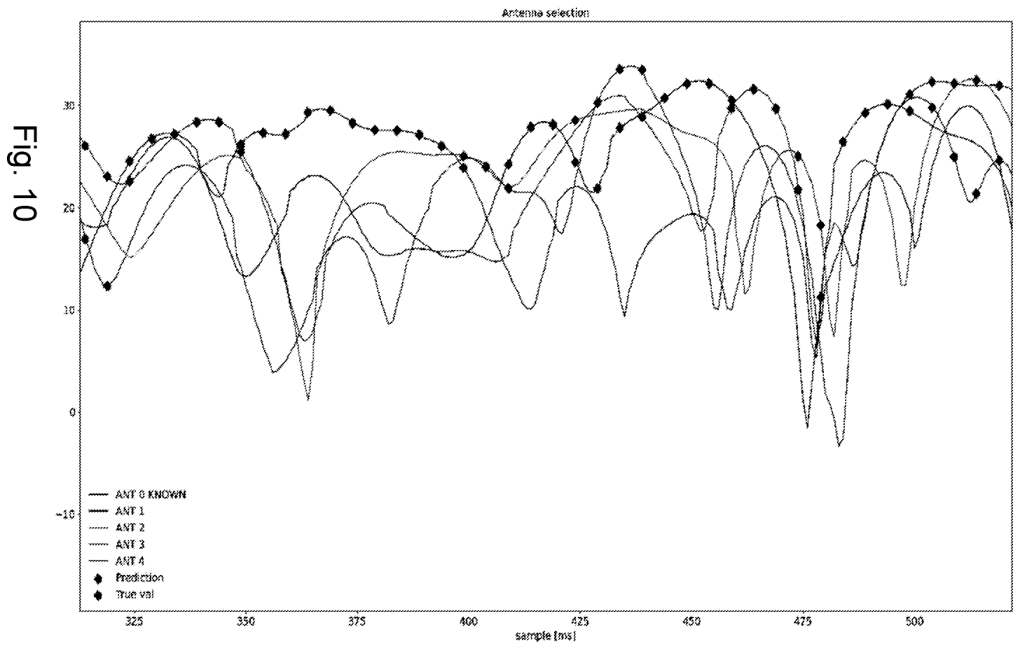

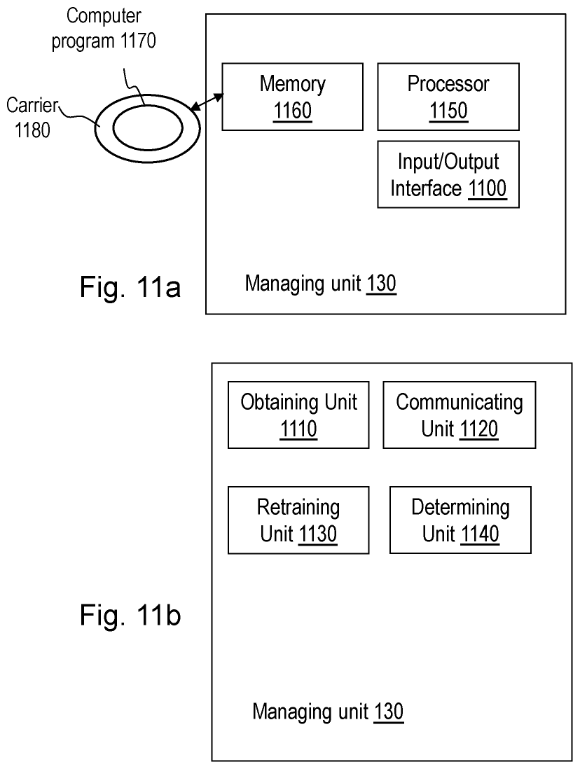

To perform the method actions above, the managing unit 130 is configured to predict the serving AP 111 among one or more APs 111, 112, 113 comprised in a subset of APs 115, to serve the UE 120 in a communications network 100. The UE 120 is adapted to be in a radio range of the one or more APs 111, 112, 113 in the subset of APs 115. The managing unit 130 may comprise an arrangement depicted in FIGS. 11a and 11b.

The managing unit 130 may comprise an input and output interface 1100 configured to communicate with APs such as e.g., APs 111, 112, 113, 121, 122, 123 and UEs such as e.g., the UE 120. The input and output interface 1100 may comprise a wireless receiver (not shown) and a wireless transmitter (not shown).

The managing unit 130 may further be configured to, e.g. by means of an obtaining unit 1110, obtain a model associated to the subset of APs 115, for predicting the serving AP, 111. The model is adapted to be obtained based on training the model over a first training period.

The training INPUT data for the model continuously with a certain periodicity is adapted to be received from one or more APs in the subset of APs 115.

The managing unit 130 according to any of the claims 16-17, may further be configured to train the model during the first training period by receiving training INPUT data for the model continuously with a certain periodicity. The training INPUT data is adapted to comprise first channel gain measurement data from each respective AP 111, 112, 113 in the subset of APs 115. The first channel gain measurement data is adapted to be measured by the particular AP 111, 112, 113 on UL reference symbols transmitted by the UE 120 and is adapted to be measured continuously with the certain periodicity within the first training period. The received training INPUT data is used for the training of the model during the first training period.

The managing unit 130 may further be configured to, e.g. by means of the obtaining unit 1110, obtain a predicted AP 111 from the subset of APs 115 to serve the UE 120. The predicted AP 111 is adapted to be obtained based on invoking the model with INPUT data for prediction. The INPUT data for prediction is adapted to comprise radio signal measurements from a set of reporting APs comprised in the subset of APs 115. In some embodiments, the model is invoked with the INPUT data for prediction continuously with a certain periodicity. The INPUT data for prediction may comprise channel gain measurement data from each respective AP in the set of reporting APs.

The managing unit 130 may further be configured to, e.g. by means of an communicating unit 1120, communicate a first indication to at least the predicted AP 111, which first indication is adapted to indicate the AP 111 that is predicted to serve the UE 120, and that only the predicted AP 111 shall forward signals received from the UE 120 to a Central Processing Unit, CPU, 140 via a fronthaul.

The managing unit 130 may further be configured to, e.g. by means of the communicating unit 1120, communicate a second indication to each respective one or more APs 111, 112, 113 in the subset of APs 115, except for the predicted AP 111. The second indication is adapted to indicate that this AP 111, 112, 113 is not a predicted AP 111 to serve the UE 120, and that this AP 111, 112, 113 do not need to forward signals received from the UE 120 to the CPU 140.

The managing unit 130 may further be configured to, e.g. by means of the retraining unit 1130, retrain the model continuously over one or more subsequent training periods, when updated training INPUT data is received. The model is adapted to be updated when the retraining has been performed.

The managing unit 130 may further be configured to, e.g. by means of the retraining unit 1130, retrain the model over the one or more subsequent training periods, continuously whenever anyone out of:
a data traffic load drops below a threshold,
a fronthaul capacity is available,
a confidence level drops below a threshold, or.
a measured hit rate drops below a threshold.

The managing unit 130 may further be configured to, e.g. by means of a determining unit 1140, determine the one or more APs 111, 112, 113 to be comprised in the subset of APs 115, by selecting the largest possible number of APs, or a part thereof, that include APs which are potentially capable of receiving a transmission of the same UE 120.

The managing unit 130 may further be configured to, e.g. by means of a updating unit 1140, when detecting that an AP subset change is required, update the subset of APs to comprise one or more second APs 121, 122, 123, by selecting the largest possible number of APs, or a part thereof, that include APs which are potentially capable of receiving a transmission of the same UE 120, and obtain an updated model for the updated subset of APs 116 comprising the one or more second APs 121, 122, 123, which updated model shall replace the model.

The managing unit 130 may be located in any one out of:
The CPU 140, or
in each AP of the comprised in the subset of APs 115 or updated subset of APs, 116, such that each AP adapted to obtain its own model by performing its own training and obtain its own predicting of AP 111.

In some embodiments, a first part of the managing unit 130 is located in the CPU 140 and a second part of the managing unit 130 is located in each AP comprised in the subset of APs 115 or updated subset of APs, 116. In these embodiments:
The first part of the managing unit 130 is configured to obtain the model and sends it to each AP of one or more APs 111, 112, 113, and
each second part of the managing unit 130 is configured to perform its own training and obtain its own predicting of AP 111.

The managing unit 130, wherein any one or more out of:

The first indication indicating that this AP 111, 112, 113 is the predicted AP 111 to serve the UE 120, is further adapted to indicate a confidence of the prediction of the predicted AP 111, and
the second indication indicating that this AP 111, 112, 113 is not a predicted AP 111 to serve the UE 120, is further adapted to indicate a confidence of not being predicted of the predicted AP 111.

Each AP 111, 112, 113 in the respective the subset of APs 115 and/or updated subset of APs 116, is adapted to comprise a respective set of multiple antennas 11, 12, 13, and any one or more out of:
the first channel gain measurement data is adapted to be measured continuously with the certain periodicity within the first training period on UL reference symbols transmitted by the UE 120 and per antenna out of the multiple antennas 11, 12, 13 of the particular AP 111, 112, 113, and
a subsequent channel gain measurement data is adapted to be measured continuously with the certain periodicity within a respective subsequent training period on UL reference symbols transmitted by the UE 120 and per antenna out of the multiple antennas 11, 12, 13 of the particular AP 111, 112, 113.

The embodiments herein may be implemented through a respective processor or one or more processors, such as the processor 1150 of a processing circuitry in the managing unit 130 depicted in FIG. 11a, together with respective computer program code for performing the functions and actions of the embodiments herein. The program code mentioned above may also be provided as a computer program product, for instance in the form of a data carrier carrying computer program code for performing the embodiments herein when being loaded into the managing unit 130. One such carrier may be in the form of a CD ROM disc. It is however feasible with other data carriers such as a memory stick. The computer program code may furthermore be provided as pure program code on a server and downloaded to the managing unit 130.

The managing unit 130 may further comprise a memory 1160 comprising one or more memory units. The memory 1160 comprises instructions executable by the processor in the managing unit 130. The memory 1160 is arranged to be used to store e.g. information, indications, symbols, data, configurations, and applications to perform the methods herein when being executed in the managing unit 130.

In some embodiments, a computer program 1170 comprises instructions, which when executed by the respective at least one processor 1150, cause the at least one processor of the managing unit 130 to perform the actions above.

In some embodiments, a respective carrier 1180 comprises the respective computer program 1170, wherein the carrier 1180 is one of an electronic signal, an optical signal, an electromagnetic signal, a magnetic signal, an electric signal, a radio signal, a microwave signal, or a computer-readable storage medium.

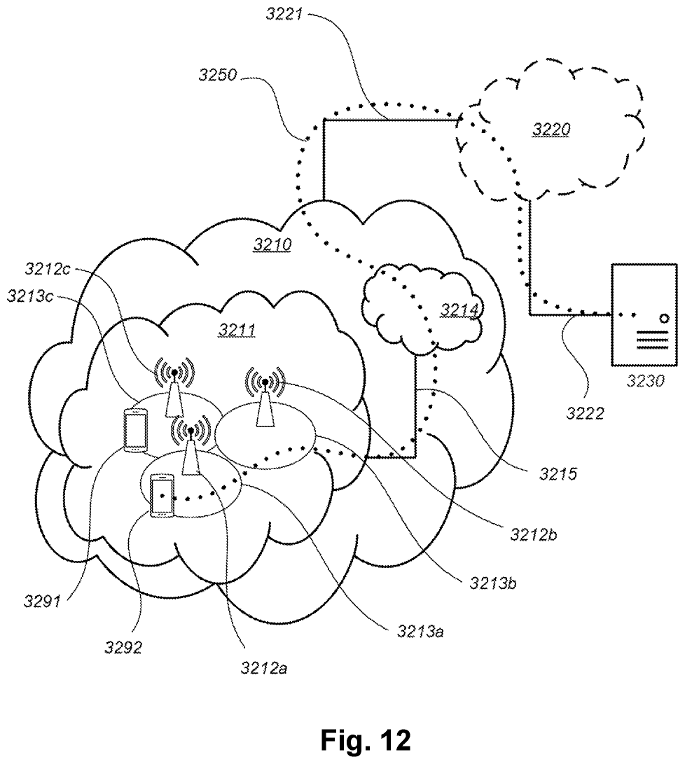

With reference to FIG. 12, in accordance with an embodiment, a communication system includes a telecommunication network 3210, such as a 3GPP-type cellular network, e.g. the communications network 100, which comprises an access network 3211, such as a radio access network, and a core network 3214. The access network 3211 comprises a plurality of base stations 3212a, 3212b, 3212c, e.g. the network node 110, such as APs 111, 112, 113, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291, e.g. the UE 120, located in coverage area 3213c is configured to wirelessly connect to, or be paged by, the corresponding base station 3212c. A second UE 3292 e.g. the UE 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

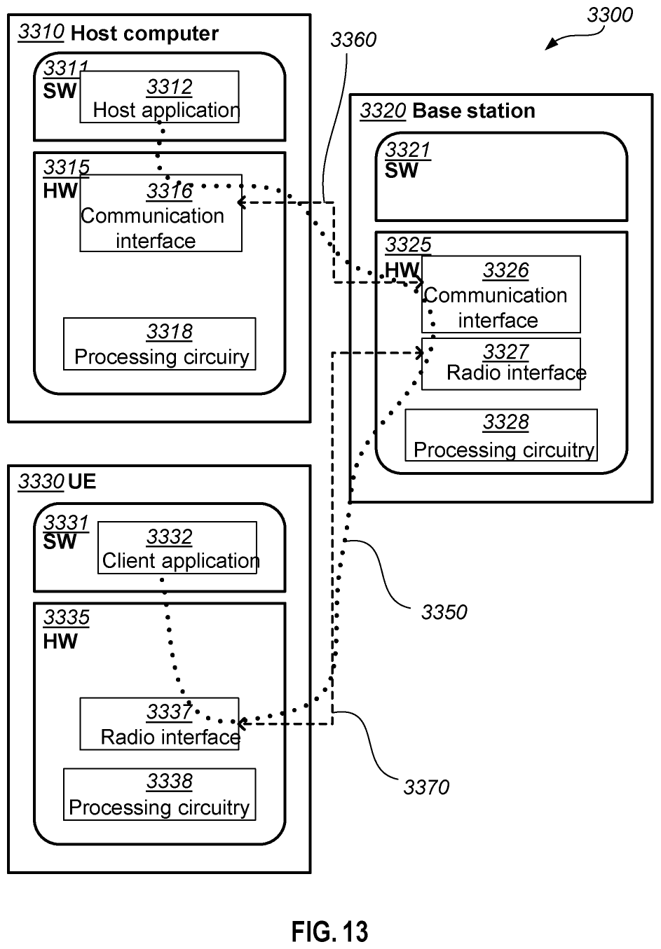

Example implementations, in accordance with an embodiment, of the UE, base station and host computer discussed in the preceding paragraphs will now be described with reference to FIG. 13. In a communication system 3300, a host computer 3309 comprises hardware 3315 including a communication interface 3316 configured to set up and maintain a wired or wireless connection with an interface of a different communication device of the communication system 3300. The host computer 3309 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3309 further comprises software 3311, which is stored in or accessible by the host computer 3309 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3309. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3309 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3309. The connection 3360 may be direct or it may pass through a core network (not shown) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3309. In the host computer 3309, an executing host application 3312 may communicate with the executing client application 3332 via the OTT connection 3350 terminating at the UE 3330 and the host computer 3309. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3309, base station 3320 and UE 3330 illustrated in FIG. 13 may be identical to the host computer 3230, one of the base stations 3212a, 3212b, 3212c and one of the UEs 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3309 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3309, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3309 and UE 3330, in response to variations in the measurement results. The measurement procedure and/or the network functionality for reconfiguring the OTT connection 3350 may be implemented in the software 3311 of the host computer 3309 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3309 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

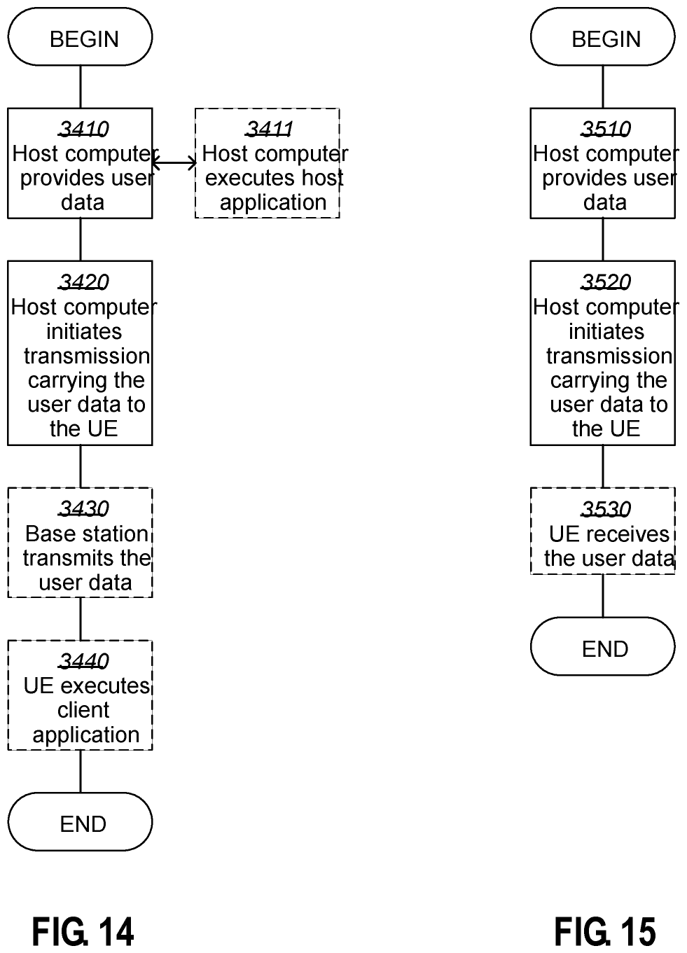

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 14 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 15 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

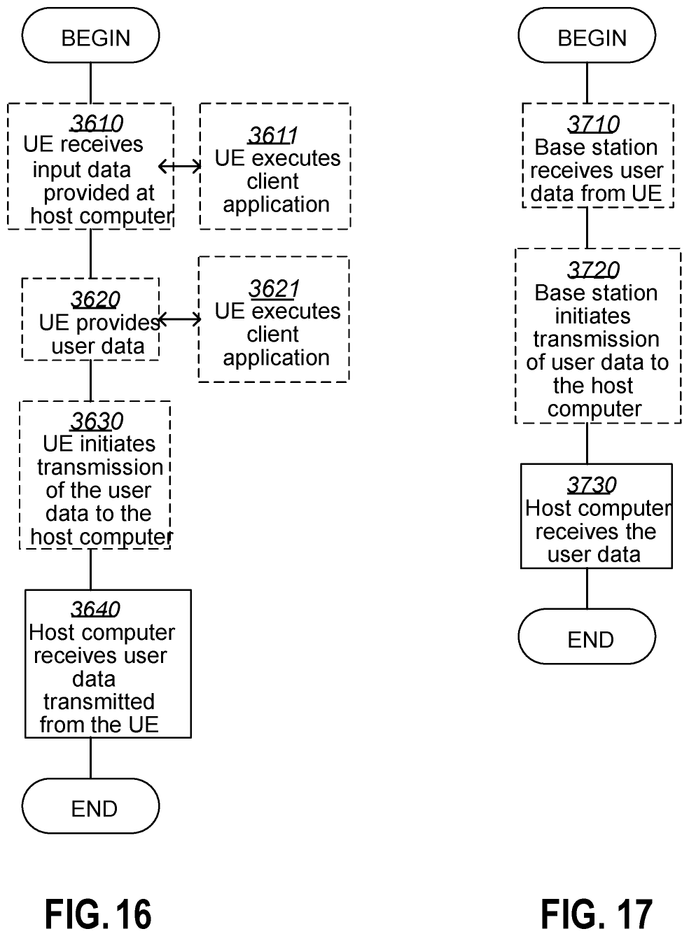

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 16 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as a AP STA, and a UE such as a Non-AP STA which may be those described with reference to FIG. 12 and FIG. 13. For simplicity of the present disclosure, only drawing references to FIG. 17 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a managing unit for predicting a serving Access Point, AP, among one or more APs comprised in a subset of APs, to serve a User Equipment, UE, in a communications network, wherein the UE is within a radio range of the one or more APs in the subset of APs, the method comprising:
obtaining a model associated to the subset of APs, for predicting the serving AP, which model is obtained based on training the model over a first training period,
obtaining a predicted AP from the subset of APs to serve the UE, which predicted AP is obtained based on invoking the model with INPUT data for prediction, which INPUT data for prediction comprises radio signal measurements from a set of reporting APs comprised in the subset of APs,
communicating a first indication to at least the predicted AP, which first indication indicates the AP that is predicted to serve the UE, and that only the predicted AP shall forward signals received from the UE to a Central Processing Unit, CPU, via a fronthaul.

2. The method according to claim 1, wherein:
the model is invoked with the INPUT data for prediction continuously with a certain periodicity, and
the INPUT data for prediction comprises channel gain measurement data from each respective AP in the set of reporting APs.

3. The method according to claim 1, wherein the training of the model during the first training period is performed by:
receiving training INPUT data for the model continuously with a certain periodicity, which training INPUT data comprises first channel gain measurement data from each respective AP in the subset of APs,
which first channel gain measurement data is measured by the particular AP on Uplink, UL, reference symbols transmitted by the UE, and is measured continuously with the certain periodicity within the first training period, and
which received training INPUT data is used for the training of the model during the first training period.

4. The method according to claim 1, further comprising:
communicating a second indication to each respective one or more APs in the subset of APs, except for the predicted AP, which second indication indicates that this AP is not a predicted AP to serve the UE, and that this AP do not need to forward signals received from the UE to the CPU.

5. The method according to claim 1, further comprising:
retraining the model continuously over one or more subsequent training periods, when updated training INPUT data is received, wherein the model is updated when the retraining has been performed.

6. The method according to claim 5, wherein the of the model over the one or more subsequent training periods, is performed continuously whenever anyone out of:
a data traffic load drops below a threshold,
a fronthaul capacity is available,
a confidence level drops below a threshold, or.
a measured hit rate drops below a threshold.

7. The method according to claim 1, wherein the training INPUT data for the model continuously with a certain periodicity is received from one or more APs of the APs in the subset of APs.

8. The method according to claim 1, further comprising:
determining the one or more APs to be comprised in the subset of APs, by selecting the largest possible number of APs, or a part thereof, that include APs which are potentially capable of receiving a transmission of the same UE.

9. The method according to claim 1, further comprising:
when detecting that an AP subset change is required, updating the subset of APs to comprise one or more second APs, by selecting the largest possible number of APs, or a part thereof, that include APs which are potentially capable of receiving a transmission of the same UE, and
obtaining an updated model for the updated subset of APs comprising the one or more second APs, which updated model shall replace the model.

10. The method according to claim 1, wherein the managing unit is located in any one out of:
the CPU), or
in each AP of the comprised in the subset of APs or updated subset of APs, such that each AP obtains its own model by performing its own training and obtains its own predicting of AP.

11. The method according to claim 1, wherein a first part of the managing unit is located the CPU and a second part of the managing unit is located in each AP comprised in the subset of APs or updated subset of APs, and wherein
the first part of the managing unit is obtaining the model and sends it to each AP of one or more APs, and
each second part of the managing unit performs its own training and obtains its own predicting of AP.

12. The method according to claim 1, wherein any one or more out of:
the first indication indicating the AP that is predicted to serve the UE, further indicates a confidence of the prediction of the predicted AP, and
the second indication indicating that this AP is not a predicted AP to serve the UE, further indicates a confidence of not being predicted of the predicted AP.

13. The method according to claim 1, wherein each AP in the respective the subset of APs and/or updated subset of APs, comprises a respective set of multiple antennas and per antenna out of the multiple antennas of the particular AP, and
a subsequent channel gain measurement data is measured continuously with the certain periodicity within a respective subsequent training period on UL reference symbols transmitted by the UE and per antenna out of the multiple antennas of the particular AP.

14.-15. (canceled)

16. A managing unit configured to predict a serving Access Point, AP, among one or more APs comprised in a subset of APs, to serve a User Equipment, UE, in a communications network, wherein the UE is adapted to be in a radio range of the one or more APs in the subset of APs, the managing unit further being configured to:
obtain a model associated to the subset of APs, for predicting the serving AP, which model is adapted to be obtained based on training the model over a first training period,
obtain a predicted AP from the subset of APs to serve the UE, which predicted AP is adapted to be obtained based on invoking the model with INPUT data for prediction, which INPUT data for prediction is adapted to comprise radio signal measurements from a set of reporting APs comprised in the subset of APs,
communicate a first indication to at least the predicted AP, which first indication is adapted to indicate the AP that is predicted to serve the UE, and that only the predicted AP shall forward signals received from the UE to a Central Processing Unit, CPU, via a fronthaul.

17. The managing unit according to claim 16, wherein:
the model is invoked with the INPUT data for prediction continuously with a certain periodicity, and
the INPUT data for prediction comprises channel gain measurement data from each respective AP in the set of reporting APs.

18. The managing unit according to claim 16, further being configured to training the model during the first training period by:
receiving training INPUT data for the model continuously with a certain periodicity, which training INPUT data is adapted to comprise first channel gain measurement data from each respective AP in the subset of APs,
which first channel gain measurement data is adapted to be measured by the particular AP on Uplink, UL, reference symbols transmitted by the UE, and is adapted to be measured continuously with the certain periodicity within the first training period, and
which received training INPUT data is used for the training of the model during the first training period.

19. The managing unit according to claim 16, further being configured to:
communicate a second indication to each respective one or more APs in the subset of APs, except for the predicted AP, which second indication is adapted to indicate that this AP is not a predicted AP to serve the UE, and that this AP do not need to forward signals received from the UE to the CPU.

20. The managing unit according to claim 16, further being configured to:
retrain the model continuously over one or more subsequent training periods, when updated training INPUT data is received, wherein the model is adapted to be updated when the retraining has been performed.

21. The managing unit according to claim 20, further being configured to retrain the model over the one or more subsequent training periods, continuously whenever anyone out of:
a data traffic load drops below a threshold,
a fronthaul capacity is available,
a confidence level drops below a threshold, or
a measured hit rate drops below a threshold.

22. The managing unit according to claim 16, wherein the training INPUT data for the model continuously with a certain periodicity is adapted to be received from one or more APs in the subset of APs.

23-28. (canceled)
